(19) United States
(12) Patent Application Publication
(10) Pub. No.: US 2025/0005688 A1
(43) Pub. Date: Jan. 2, 2025

(54) AN ELECTRONIC DEVICE, A SYSTEM, AND A METHOD FOR CONTROLLING A VICTUAL ORDERING SYSTEM

(71) Applicant: Sony Group Corporation, Tokyo (JP)

(72) Inventors: Hannes BERGKVIST, Rydeback (SE); Peter EXNER, Malmö (SE)

(21) Appl. No.: 18/708,847

(22) PCT Filed: Oct. 25, 2022
(86) PCT No.: PCT/EP2022/079740

§ 371 Date: May 9, 2024

(30) Foreign Application Priority Data
Nov. 30, 2021 (SE) 2151457-5

(51) Int. Cl. G06Q 50/12; G06Q 30/0601; G06V 20/68; G06V 40/16

(52) U.S. Cl. CPC G06Q 50/12; G06Q 30/0631; G06V 20/68; G06V 40/161

(57) ABSTRACT

An electronic device is provided. The electronic device is configured to obtain, from an optical device, detection data indicative of an item. The electronic device is configured to control, based on the detection data, a victual ordering system.

The present disclosure pertains to the field of Internet of things (IoT) and detection devices, and relates to an electronic device and to a method for controlling a victual ordering system.

### BACKGROUND

In general, as a non-local guest at a restaurant serving sharing type of food, it can be an overwhelming task to know and decide what to order and what quantities. The responsibility to recommend a suitable set of dishes often falls on the host of the establishment. While tasting menus can be offered by restaurants and designed for specific group sizes, it may be challenging to consider the large variation given by group demographics and/or personal preferences. One challenge lies in recommending a set of dishes that deliver a harmonic taste journey while considering for example the calorific intake and/or personal preferences of both the group and the individuals within. Another challenge lies in aiding restaurants in adhering to national legislation regarding sustainable consumption and food waste.

### SUMMARY

Accordingly, there is a need for electronic devices and methods for controlling a victual ordering system, which may mitigate, alleviate, or address the shortcomings existing and may provide the control of a victual ordering system.

An electronic device is provided. The electronic device comprises memory circuitry, processor circuitry, and interface circuitry. The electronic device is configured to obtain, from an optical device, detection data indicative of an item. The electronic device is configured to control, based on the detection data, a victual ordering system.

Further a method performed by an electronic device is disclosed. The method comprises obtaining, from an optical device, detection data indicative of an item. The method comprises controlling, based on the detection data, a victual ordering system.

Further, a system is disclosed herein, the system comprising an electronic device as disclosed herein and one or more electronic devices as disclosed herein.

The disclosed electronic device, related method, and system may provide an improved controlling of a victual ordering system.

The disclosed electronic device, related method, and system may provide improved controlling of a victual ordering system, for example by providing menu data indicative of a victual menu. The menu data may comprise sharing menu recommendations. In other words, a victual ordering system may be controlled based on sharing menu recommendations. A sharing menu recommendation may comprise a recommendation for specific group sizes comprising one or more subjects, such as considering personal preferences of the one or more subjects of a group of subjects. A personal preference may comprise a calorific intake with personal preferences. The present disclosure may provide menu data indicative of a sharing menu for a group of subjects, such as a shared menu recommendation for a group of subjects. The menu data may be based on an individual assessment of the subjects (such as guests) considering detection data and/or user input, such as gender, age, additional information on activity level, and personal preference. Further, the present disclosure may improve the controlling of a victual ordering system by facilitating selecting and/or adapting dishes to a subject. For example, it may be appreciated that the controlling of a victual ordering system may comprise to compose a customized taste journey and/or select dishes for a nutritionally balanced meal based on a group of subjects composition and/or based on an individual subject. Further, the present disclosure may provide menu data comprising food recommendations at an individual level, for example obtained via user input by utilizing the knowledge from one or more electronic devices such as fitness bands and/or activity trackers.

It may be appreciated that the present disclosure may provide the possibility to obtain detection data for example to monitor intake continuously and encourage consumption of specific dishes to attain a nutritionally balanced meal. Further, detection data may be used to continuously consider a calorific intake potential of subjects (such as guests) to enable sustainable consumption and avoid food waste. It may be appreciated that the present disclosure may help eating places (such as restaurants) to adhere to national regulations, such as food waste prevention legislation.

Further, the disclosed electronic device, related method and system may improve the logistics of a victual ordering system (such as of an eating place). For example, the present disclosure may improve the efficiency and/or reduce the labor of the employees of an eating place and may save time and money for both subjects (such as guests) and the eating place.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a block diagram illustrating an example system comprising an electronic device according to this disclosure, and

FIG. 2 is a flow-chart illustrating an example method, performed by an electronic device according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

The figures are schematic and simplified for clarity, and they merely show details which aid understanding the disclosure, while other details have been left out. Throughout, the same reference numerals are used for identical or corresponding parts.

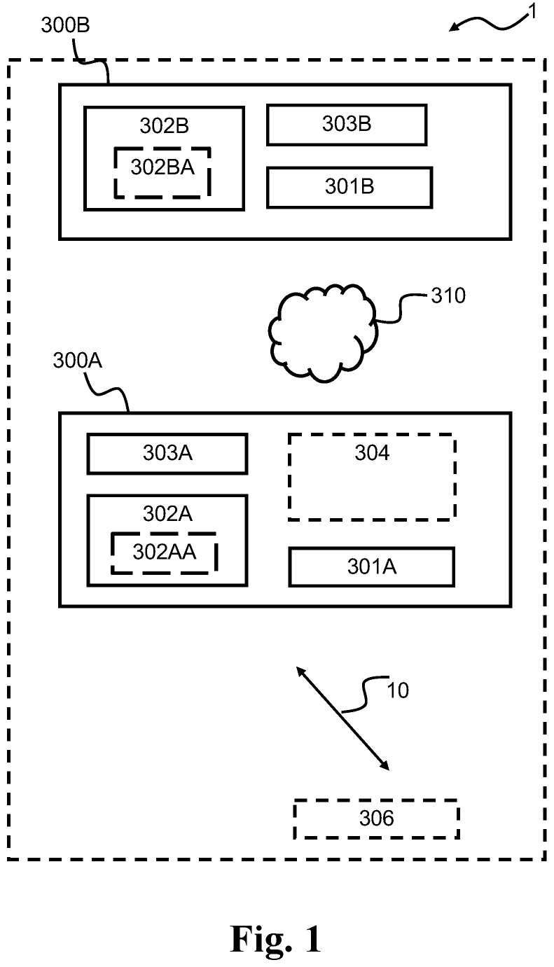

FIG. 1 shows an example system 1 comprising an electronic device 300B according to the disclosure acting as a server device, an electronic device 300A according to the disclosure acting as an electronic device (such as an optical device). The system 1 may for example be a victual ordering system. The system 1 may be a victual ordering system comprising the electronic device 300A and/or electronic device 300B.

FIG. 1 shows a block diagram illustrating an electronic device 300B according to the disclosure acting as a server device and a block diagram illustrating an electronic device 300A acting as an electronic device (such as an optical device), Optionally, the system 1 (such as victual ordering system) may comprise a victual ordering device 306. The victual ordering device 306 may comprise one or more user electronic devices, such as one or more user electronic devices at a table of a victual consumption place, such as an eating place (such as at a table of a restaurant), to allow a subject (such as a group of subjects) to provide a user input. The victual ordering device 306 may comprise one or more user devices, such as a user electronic device and/or a terminal in a kitchen of a victual consumption place (such as eating place), where menu data (such as a victual menu, for example an accepted victual menu) may be displayed and/or dispatched. In other words. the victual ordering device 306 may be configured to display menu data, such as configured to display a victual menu, to one or more employees of a victual consumption place (such as eating place), to inform the employees that a content of the victual menu is to be prepared and/or served. In other words, the victual ordering device 306 may be controlled by the electronic device 300A, 300B based on detection data and/or the electronic device 300A, 300B may be configured to communicate with the victual ordering device 306. Optionally, the system 1 (such as victual ordering system) may comprise a victual ordering device 306 communicating with and/or comprising a victual delivery machine (such as eatable delivery machine). A victual delivery machine may be configured to prepare and/or deliver victual products based on the menu data. In other words, a victual delivery machine may be controlled by the electronic device 300A, 300B based on detection data. A victual ordering system may be seen as a system operating at a location (such as victual consumption place, such as a restaurant, a canteen, café, or the like) where victual products (such as eatable and/or drinkable products) and/or items may be prepared (such as in a kitchen) and/or delivered, victual products and/or items may be ordered by subjects, and subjects may consume victual products and/or items (such as eatables and/or drinkables).

The electronic device 300A acting as an electronic device may be configured to communicate with the electronic device 300B acting as a server device via a network 310 (such as an external network, for example a wired communication system and/or a wireless communication system).

In one or more example electronic devices, the electronic device 300A is an electronic device that may comprise the victual ordering device 306. In one or more example electronic devices, the electronic device 300A may comprise an optical device (such as a camera). In one or more example electronic devices, the victual ordering device 306 may comprise memory circuitry, interface circuitry (such as a display), and processor circuitry. In one or more example electronic devices and/or systems, an optical device (such as a camera) may be placed and/or positioned such that a substantially unobstructed view of items at a victual location is provided. In other words, an optical device (such as a camera) may be placed such that a substantially unobstructed view of one or more victual objects, one or more subjects, a pose of one or more subjects, and/or a face of one or more subjects at a victual location (such as at a table of a victual location) is provided. For examples, an optical device (such as a camera) may be placed and/or positioned such that a substantially unobstructed view of plates at a victual location (such as at one or more tables of a restaurant) is provided. An optical device with an unobstructed view may for example provide for continuous analysis of items. An example setup may comprise one optical device per table at a victual location. A positioning of an optical device may be based on the positioning and/or seating of subjects (such as guests) at a victual location. An optical device may be positioned in such a way that the optical device may obtain detection data from one or more groups of patrons, such as one or more patron recognitions.

In one or more examples, the system 1 comprises a victual ordering system such as a food ordering system and/or a drinks ordering system. The system 1, such as the victual ordering device, may comprise one or more of: an electronic slate, a tablet, a smart phone, a touch enabled food ordering system, and/or a laptop.

In one or more example electronic devices, the electronic device 300B is a server device, such as acting as a server device.

The electronic device 300A, 300B comprises memory circuitry 301A, 301B, interface circuitry 303A, 303B, and processor circuitry 302A, 302B. Optionally, the processor circuitry 302A comprises inference circuitry 302AA configured to run, execute, and/or operate according to a detection model, such as a first detection model. Optionally, the processor circuitry 302B comprises inference circuitry 302BA configured to run, execute, and/or operate according to a detection model. Optionally, the inference circuitry 302AA, 302BA may comprise a recommendation engine as disclosed herein. The electronic device 300A may comprise a detection device (such as one or more of an optical device, a microphone, and a temperature sensor), a portable electronic device, a wireless device, a wired device, and/or an IoT device.

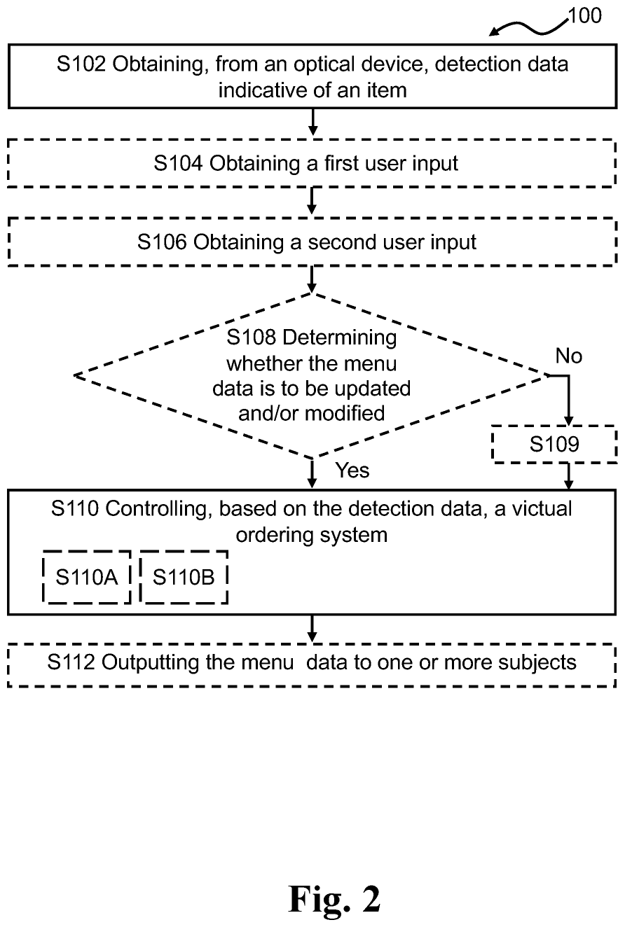

The electronic device 300A, 300B may be configured to perform any of the methods disclosed in FIG. 2. In other words, the electronic device 300A, 300B may be configured to control the victual ordering system, such as for providing menu data comprising for example sharing menu recommendations.

The technique disclosed in the present disclosure may for example be applied in the context of controlling (such as monitoring) a victual ordering system of a location, such as a victual consumption place, such as a restaurant, a canteen, a café, an eating house, a dining room, a bistro and/or the like.

The electronic device 300A, may comprise an optical device 304, such as first optical device, such as a camera (such as a micro camera, and/or on-board camera sensor).

The electronic device 300A, 300B is configured to obtain (such as using the processor circuitry 302A, 302B and/or via the interface circuitry 303A, 303B), from an optical device, detection data indicative of an item (such as an item comprising one or more of: an object, such as a dish, a subject, and a face). In one or more example electronic devices, the item may be seen as an item of a restaurant, a person and/or a group of persons in at a location, such as at such as a victual consumption place, such as a restaurant, canteen, etc.

The obtaining of detection data may comprise to obtain first detection data and/or second detection data. The obtaining of detection data may comprise to obtain detection data from a plurality of optical devices. In one or more example electronic devices, the electronic device is configured to obtain the detection data from one or more optical devices at a location, such as a victual consumption place, such as a restaurant, a food take-away place, a canteen, a food truck, and/or the like.

An optical device as disclosed herein (such as the optical device 304) may be seen as a camera that may comprise a vision sensor, such as vision based on one or more patrons recognition. In one or more example electronic devices, the optical device (such as the optical device 304) may comprise a vision sensor, and/or processing circuitry configured to run and/or execute a detection model. In one or more example electronic devices, an optical device may be seen as one or more of: an on-board camera, a micro camera, an action camera, a surveillance camera, a mirrorless camera, a 360-degree view camera, and an infrared camera. In one or more example electronic devices, an optical device may comprise memory circuitry, interface circuitry, and processing circuitry configured to run and/or execute a detection model. In one or more example an optical device may be configured to detect one or more of: movement of a subject, subject movement patterns, movements of group of subjects, position and/or quantity of items (such as a table, a chair, a bowl, a plate, a glass etc.)

The electronic device 300A may be configured to obtain detection data indicative of user activity information from a user electronic device. A user electronic device may comprise one or more of: an armband, a wrist band, an activity tracker, smart glasses, a smart phone and/or a wearable electronic device (such as smart finger rings). In one or more example electronic devices, the user activity information may comprise one or more of:

user physical activity routine information (such as number steps walked, type of workouts at gym), calorific intake, food intake, caffeine intake, etc. In one or more example electronic devices, the user activity information may comprise health related information such as body mass index value, blood pressure, glucose level, and/or stress level.

The electronic device is configured to control (such as using the processor circuitry 302A, 302B and/or via the interface circuitry 303A, 303B), based on the detection data, a victual ordering system, such as the victual ordering system 1, such as a food ordering system. In one or more example electronic devices, controlling the victual ordering system may comprise outputting information indicative one or more victual items (such as a food item) to a user of the victual ordering system and/or to a victual ordering device, such as the victual ordering device 306. In one or more example electronic devices, controlling the victual ordering system may comprise displaying information (such as menu data) indicative one or more victual items (such as a food item) to a user of the victual ordering system and/or to a victual ordering device, such as the victual ordering device 306. In one or more example electronic devices, controlling the victual ordering system may comprise outputting, such as displaying, information (such as menu data) indicative of a suggestion and/or recommendation (such as suggestion and/or recommendation of a menu comprising one or more victual items, such as one or more food items and/or drink items) to the user. In one or more electronic devices, controlling the victual ordering system may comprise controlling one or more victual orders, such as food and/or drink orders of a victual consumption place. For example, controlling the victual ordering system may comprise controlling a production (such as preparation) of victual products and/or items at a victual consumption place, such as in a kitchen of a victual consumption place. For example, controlling the victual ordering system may comprise controlling an ordering of raw victual products and/or items that the victual products and/or items are to be prepared of, such as victual commodities (such as fresh food and/or drink products). For example, controlling the victual ordering system may comprise controlling a prioritizing of production of victual products and/or items, such as in a kitchen. In other words, prioritizing the preparation of a set of victual products and/or items for a group of subjects that have ordered at the same time, so that they get the victual products and/or items they have ordered at substantially the same time. For example, controlling the victual ordering system may comprise controlling a production (such as preparation) of victual products and/or items at a victual consumption place based on a stock level of victual products and/or items, such as a stock level of victual commodities (such as fresh food and/or drink products).

The system 1 may optionally comprise a network node (such as a base station, not shown) that the electronic device 300B acting as server device, the electronic device 300A, and/or the victual ordering device 306 may communicate through. A network node refers to an access point and/or radio access network node operating in the radio access network, such as a base station, an evolved Node B, eNB, next generation Node B, gNB in New Radio, NR. In one or more examples, the Radio Access Network, RAN node is a functional unit which may be distributed in several physical units.

The electronic device 300A, 300B and the victual ordering device 306 may use, such as via the interface circuitry 303A, 303B a cellular system, for example, a 3GPP wireless communication system and/or the internet, and/or a local communication system, such as 10 short-range wireless communications systems, such as Wi-Fi, Bluetooth, Zigbee, IEEE 802.11, IEEE 802.15 to communicate. The electronic device 300B acting as server device may be seen as a device configured to act as a server in communication with a client device, where the electronic device 300A, the optical device, and/or the victual ordering device 306 are configured to act as clients.

In one or more example electronic devices, the detection data comprises one or more of: a subject parameter, a group of subjects parameter, an object parameter, a face parameter, a victual parameter, a victual tracking parameter, and a radio sensing parameter.

A subject parameter may be seen as a parameter associated with a subject, such as a detected subject (such as detected by the optical device). For example, a subject parameter may comprise information indicative of a subject item such as a user, for example, a subject at a location (such as at a restaurant, a canteen, a food truck, and/or a food take-away place) and/or a user operating the victual ordering device 306 being a user electronic device. A subject parameter may be seen as comprising information indicative of an item such as a user demographics, such as an age of a subject, a gender of a subject, and/or a physical parameter of a subject (such as a height parameter indicative of height of the user, a weight parameter indicative of weight of the user).

A group of subjects parameter may be seen as a parameter associated with a group of subjects, such as a detected group of subjects (such as detected by the optical device). A group of subjects parameter may be seen as comprising information indicative of one or more subjects of a subject group. For example, a group of subjects parameter may comprise one or more users in a group, such as a group comprising one or more users at a location (such as at a restaurant, a canteen, a food truck, and/or a food take away place) and/or a group of users operating the victual ordering device (such as the user electronic device). A group of subjects parameter may be seen as comprising information indicative of number of subjects (such as users) in a group at a victual location. In other words, the electronic device 300A, 300B may be configured to identify a number of subjects at a victual location, such as using the optical device and/or the vision sensor. A group of subjects parameter may be seen as comprising information indicative of number of subjects demographics, such as age of the subjects of a group (such as mean age of the subjects of the group), gender of the subjects of a group, and/or physical parameters of the subjects of a group (such as height of the subjects of a group).

An object parameter may be seen as a parameter associated with an object, such as a detected object (such as detected by the optical device). An object parameter may be seen as comprising information indicative of an object item, such as one or more objects at a victual location (such as at a restaurant, a canteen, a food truck, and a food take away place). An object parameter may be indicative of one or more of: cutlery, a plate, a bowl, a glass, a cup, a chair, and a table.

A face parameter may be seen as a parameter associated with a face, such as a detected face (such as detected by the optical device). A face parameter may be seen as comprising information indicative a face item, such as a facial feature of one or more subjects. The facial feature may be indicative of one or more of: an eye, a nose, a mouth, an ear, chin, forehead, and skin.

In one or more example electronic devices, the detection data comprises a pose parameter. A pose parameter may be seen as a parameter associated with a pose of one or more subjects (such as detected by the optical device). A pose parameter may be seen as comprising information indicative of a pose item, such as one or more poses of one or more subjects at a victual location (such as at a restaurant, a canteen, a food truck, and a food take away place). A pose parameter may be indicative of one or more of: one or more subjects eating, drinking, not eating, ordering, and/or sitting. The controlling of the victual ordering system may be based on a pose parameter. For example, when a pose parameter is indicative of a subject not eating, which may indicate that the subject is done with a victual item that was served, the electronic device 300A, 300B may be configured to control the victual ordering system to prepare and/or serve a next victual item to the subject. Another example may be that a pose parameter is indicative of a group of subjects not eating, which may indicate that the group of subjects is done (such as finished) with their victual items that were served, such as the group of subjects being done with a starter they have ordered. In accordance with the pose parameter indicating that the group of subjects being done with their victual items, the electronic device 300A, 300B may be configured to control the victual ordering system to prepare and/or serve a next victual item to the group of subjects, such as to prepare and/or serve a main course.

A victual parameter may be seen as a parameter associated with a victual item and/or object, such as a detected victual item and/or object (such as detected by the optical device). A victual parameter may be seen as comprising information indicative of a victual item such as a food item (such as a starter, a main course, a side dish, a dish, a drink, a salad, a soup, a dessert, etc.). A victual tracking parameter may be seen as a parameter associated with a consumption of a victual item and/or object, such as a detected consumption of a victual item and/or object (such as detected by the optical device). A victual tracking parameter may be seen as comprising information indicative of one or more of: a consumption of a victual item, quantity of the victual item, portion of the victual item, a state of consumption, and a state (such as solid, liquid, hot and/or cold) of the victual item.

A radio sensing parameter may be seen as a parameter associated with a sensing of radio waves. A radio sensing parameter may be seen as comprising information indicative of electronic device sensing, such as near-field communication, NFC, Wi-Fi, Bluetooth low energy, BLE, to sense a number of electronic devices such as phones, smart watches, and/or to sense a type of electronic device.

In one or more example electronic devices, the item comprises one or more of: a victual object, one or more subjects, a pose, and a face. In other words, an item as disclosed herein may comprise one or more of: a subject item, a group of subjects item, an object item, a face item, and a victual item. In other words, the detection data is indicative of one or more of a victual object, one or more subjects, a pose, and a face.

A subject item may be seen as an item being indicative of a subject, such as a person and/or a user. A subject may comprise a subject present at a victual consumption place to be controlled by the electronic device as disclosed herein, and/or a subject using the victual ordering device 306 acting as user electronic device.

A pose may be seen as a pose of a subject eating, drinking, not eating, ordering, and/or sitting, etc. In one or more example electronic devices, the electronic device 300A, 300B may be configured to obtain item information indicative of a pose (such as pose information) from the optical device (such as optical device 304). The electronic device 300A, 300B may be configured to recognize and/or identify an activity and/or a status, such as a consumption status of one or more subjects, based on a detection of a pose of one or more subjects. For example, the electronic device 300A, 300B may be configured to recognize that one or more subjects are eating, drinking, not eating, ordering, and/or sitting, based on the detection of a pose. In one or more example electronic devices, the electronic device 300A, 300B may be configured to control the victual ordering system based on the detection of one or more poses, such as the detection data comprising a pose parameter.

A group of subjects may be seen as an item being indicative of a group comprising one or more subjects, such as one or more persons and/or one or more users. A group of subjects may comprise one or more subjects present at a victual consumption place. In one or more example electronic devices, the electronic device 300A, 300B may be configured to obtain item information indicative of a group of subjects (such as group of subjects information) from one or more optical devices (such as the optical device 304).

An object may be seen as an item being indicative of a tangible item (such as a plate, a glass, a table, a chair, a spoon, a fork, a knife, etc.) present at a victual consumption place. The object may be configured to hold one or more victual items (such as food, drinks, soups, etc.). In one or more example electronic devices, the electronic device 300A, 300B may be configured to obtain item information indicative of an object (such as object information) from one or more optical devices (such as the optical device 304).

A face may be seen as an item being indicative of a face of a subject (and/or one or more faces of subjects in a group of subjects) at a victual consumption place (such as at a restaurant, a food take away place, a food truck, a canteen etc.). The face may comprise one or more of: an eye of a subject, a nose of a subject, a mouth of a subject, a cheek of a subject, a beard of a subject, and an ear of a subject. In one or more example electronic devices, the electronic device 300A, 300B may be configured to obtain item information indicative of a face (such as face information) from one or more optical devices (such as the optical device 304). The electronic device 300A, 300B may be configured to recognize and/or identify one or more subjects based on a detection of a face. For example, the electronic device 300A, 300B may be configured to recognize and/or identify a gender of one or more subjects, an identity of one or more subjects, an age of one or more subjects, and/or a mood of one or more subject, based on the detection of a face. In one or more example electronic devices, the electronic device 300A, 300B may be configured to control the victual ordering system based on the detection of one or more faces, such as the detection data comprising a face parameter.

A victual object may be seen as an item being indicative of a victual item such as a food item (such a meal, a drink, a dessert, a soup, combination of food items, etc.) at a victual consumption place. In other words, the victual object may be seen an item that is consumed by a subject at a victual consumption place. In one or more example electronic devices, the electronic device 300A, 300B may be configured to obtain the victual object information from one or more optical devices (such as the optical device 304). In one or more example electronic devices, the electronic device 300A, 300B may be configured to display a user interface object representing a victual object via the victual ordering device 306.

In one or more example electronic devices, the electronic device 300A, 300B comprises a recommendation engine. In one or more example electronic devices the recommendation engine may comprise and/or be configured to run a deep neural network. In one or more example electronic devices, the deep neural network may be an offline trained neural network. In one or more example electronic devices, the deep neural network may be trained dynamically at a victual place. In one or more example electronic devices, the recommendation engine may be configured to output menu data based on the output of the deep neural network. In one or more electronic devices, the recommendation engine may comprise and/or be configured to run a trained neural network. In one or more electronic devices, the recommendation engine may be trained dynamically based on the detection data, menu data (such as historical menu data), user input, and/or group of users input.

In one or more example electronic devices, the recommendation engine may comprise a neural network, which comprises one or more input layers, one or more intermediate layers, and one or more output layers. In one or more example electronic devices, an input to the recommendation engine may comprise one or more of: detection data indicative of an item and/or one or more user inputs (such as the first user input). In other words, an input to the recommendation engine may comprise one or more of: a subject parameter, a group of subjects parameter, an object parameter, a face parameter (such as a facial expression parameter), a victual parameter, a victual tracking parameter, a radio sensing parameter, a victual preference parameter, an allergy parameter, a taste parameter, a price parameter, a duration parameter, and an activity parameter. An input to the recommendation engine may comprise user activity information, a user input such as a first user input indicative of user's choice and/or preferences (such as selecting, adding, and/or removing of a victual item from a victual menu). In one or more example electronic devices, the input to the recommendation engine may comprise input from a detection model.

In one or more example electronic devices, the recommendation engine may consider, as an input, one or more of: a time parameter indicative of time (such as time of the day), a date parameter indicative of a date, and/or a season parameter indicative of a season at a location (such as indicative of a type of weather associated with a season of the year, for example, summer, autumn, winter, or spring), a weather parameter indicative of weather at a location (such as snowing, raining, sunshine, hot, cloudy, showers), a caution parameter indicative of cautious information (such as water quality at a location, alerts from corresponding institutions, daily news), and a stock level of victual products and/or items, such as a stock level of victual commodities (such as fresh food and/or drink products). In one or more example electronic devices, the recommendation engine may output, such as a first output comprising menu data, such as first menu data, indicative of a recommendation of a victual menu, such as a first victual menu. In one or more example electronic devices, the recommendation engine may output one or more recommendations (such as suggestions, advice, proposal, reminders, and/or warnings) to one or more subjects at a victual consumption place, such as a group of subjects at a victual consumption place. The first victual menu may comprise recommendation of one or more victual items (such as a food item indicative of food). In one or more example electronic devices, the recommendation engine may be configured to consider a second user input as input. In one or more example electronic devices, the electronic device 300A, 300B may configured to run and/or execute the recommendation engine using the processor circuitry 302A, 302B and/or via the interface circuitry 303A, 303B.

In one or more example electronic devices, the recommendation engine may be configured to modify the first victual menu (such as the menu data) and/or generate a second victual menu (such as an updated victual menu recommendation) based on a second user input. For example, a second user input may be indicative of a user's choice and/or preferences (such as accepting, refusing, modify, selecting, adding, and/or removing of a victual item from a victual menu).

In one or more electronic devices, the electronic device 300B acting as a server device may comprise a recommendation engine. In one or more electronic devices, the input to the electronic device 300B, such as an input to the recommendation engine, may comprise one or more of: detection data indicative of an item from the electronic device 300A, user input from a user, such as user input provided via the victual ordering device 306. In one or more electronic devices, the electronic device 300B may be configured to generate such as output, based on the input, menu data indicative of a victual menu. In one or more electronic devices, the electronic device 300B may be configured to control the victual ordering system based on the menu data and/or transmit the menu data to the electronic device 300A. In one or more electronic devices, controlling the victual ordering system may comprise displaying the output generated by the electronic device 300B.

In one or more example electronic devices, the recommendation engine is based on one or more of: collaborative filtering, content-based filtering, session-based recommender, and hybrid systems combining any one or more of the previous. In other words, the electronic device as disclosed herein (such as electronic device 300A, 300B) may comprise a recommendation engine based on one or more of: collaborative filtering, content-based filtering, session-based recommender, and hybrid systems combining any one or more of the previous. The recommendation engine disclosed herein may consider detection data indicative on an item, a user input, such as a first user input, for example an input from a user electronic device. A recommendation engine as disclosed herein may provide an output such as menu data indicative of a victual menu.

In one or more example electronic devices, the controlling of the victual ordering system comprises to generate, based on the detection data, using the recommendation engine, and optionally a user input (such as the first user input), menu data indicative of a victual menu. In one or more example electronic devices, the recommendation engine may generate menu data, such as a victual menu indicative of a sharing menu recommendation based on one or more of: collaborative filtering, content-based filtering, session-based recommender, and hybrid systems combining any one or more of the previous.

In one or more example electronic devices, the recommendation engine comprising a machine learning, ML, model (such as being configured to run an ML model) may be configured to generate, based on a content-based filtering algorithm, menu data (such as a victual menu indicative of a sharing menu recommendation). In other words, the recommendation engine may use content-based filtering algorithm to generate menu data. In one or more example electronic devices, the recommendation engine comprising a content-based filtering algorithm, may be configured to generate menu data based on one or more features of an item (such as based on feature extraction).

In one or more example electronic devices, the recommendation engine comprising a ML model (such as being configured to run an ML model) may be configured to generate, based on collaborative filtering, menu data (such as a victual menu indicative of a sharing menu recommendation). In one or more example electronic devices, the recommendation engine comprising a collaborative filtering algorithm, may be configured to generate menu data based on a user input associated with the one or more features of an item (such as based on feature extraction).

In one or more example electronic devices, the recommendation engine comprising a ML model (such as being configured to run an ML model) may be configured to generate, based on session-based recommender, menu data (such as a victual menu indicative of a sharing menu recommendation). In one or more example electronic devices, the recommendation engine using a session-based recommender, may be configured to generate menu data based on a user input in an ongoing session at a victual consumption place (such as user input during a dinner at a restaurant, or at a party in a bar).

In one or more example electronic devices, the recommendation engine comprising a ML model (such as being configured to run an ML model) may be configured to generate, based on a hybrid system (comprising one or more of: collaborative filtering, content-based filtering, and session-based recommender), menu data (such as a victual menu indicative of a sharing menu recommendation). In one or more example electronic devices, the recommendation engine comprising a hybrid system, may be configured to generate menu data.

In one or more example electronic devices, the electronic device 300A, 300B is configured to control the victual ordering system. The controlling of the victual ordering system may comprise to generate menu data indicative of a victual menu. The victual menu may comprise one or more victual items, such as a food item. In one or more example electronic devices, the electronic device 300A, 300B may generate the menu data indicative of the victual menu using the recommendation engine. In one or more example electronic devices, the electronic device 300A, 300B may use detection data to generate the menu data. In one or more example electronic devices, the electronic device 300A, 300B may use user input (such as the first user input) to generate the menu data. In one or more example electronic devices, the electronic device 300A, 300B may use the user activity information to generate the menu data. In one or more example electronic devices, the electronic device 300A, 300B may use a user input comprising information from a subject's associated internet service account (such as a health portal, a travel portal, a blog, and/or food portal) to generate menu data. In one or more example electronic devices, the electronic device 300A, 300B may use historical menu data, such as user history data (such as previous visits to the restaurant, previous menus preferred by the user or a group of users) to generate the menu data.

In one or more example electronic devices, the electronic device 300A, 300B is configured to control (such as using the processor circuitry 302A, 302B and/or via the interface circuitry 303A, 303B) the victual ordering system based on the menu data. In one or more example electronic devices, controlling the victual ordering system, based on the menu data, may comprise to output the menu data to an electronic device such as a user electronic device (such as a tablet, a display, and/or a TV). In one or more example electronic devices, controlling the victual ordering system, based on the menu data, may comprise to output the menu data to the victual ordering device 306.

In one or more example electronic devices, controlling the victual ordering system, based on the menu data, may comprise when a user accepts the victual menu, such as accepts the menu data indicative of a victual menu by providing a user input (such as inputting an acceptance of the victual menu), to send and/or dispatch the menu data to an electronic device, such as a user electronic device in a kitchen of a victual consumption place. For example, the electronic device 300A, 300B may be configured to send and/or dispatch the menu data to an electronic device configured to display menu data, such as display victual menu. The content of the menu data that has been prepared may then be served when the victual products of the menu data are ready. For example, the electronic device 300A, 300B may be configured to send and/or dispatch the menu data to an electronic device, such as a terminal and/or a tablet, in a victual preparation area (such as food preparation area, for example a kitchen in a restaurant).

In one or more example electronic devices, the menu data comprises data indicative of a sharing menu (such as a collaborative menu) for a group of subjects. In other words, the electronic device 300A, 300B may be configured to generate a sharing menu for a group of subjects. The electronic device 300A, 300B may be configured to identify one or more victual items and/or products (such as ingredients, dishes, and/or drinks) in common that the subjects of a group of subjects have a preference for.

In one or more example electronic devices, the electronic device 300A, 300B is configured to generate menu data indicative of a victual menu. The victual menu may comprise one or more victual items, such as a food item. In one or more example electronic devices, the electronic device 300A, 300B may obtain detection data indicative of an item. In one or more example electronic devices, the electronic device 300A, 300B may generate, using the recommendation engine, menu data based on one or more of: the detection data, subject input (such as user input), group of subjects input (such as group of users input, such as input from one or more individuals in a group) and/or the detection model. In one or more example electronic devices, the menu data may comprise a victual menu for a group of subjects. A victual menu for a group of subjects may comprise one or more victual items (such as a food item) for each of the subjects of a group of subjects. In one or more example electronic devices, the victual menu may comprise a sharing menu for a group of subjects, such as a collaborative menu for a group of subjects. A sharing menu as disclosed herein may be seen as a victual menu with one or more victual items shared for consumption among a group of subjects. In one or more example electronic devices, the menu data may comprise one or more sharing menus (such as victual menus) corresponding to one or more individual subjects in a group of subjects.

In one or more example electronic devices, the electronic device 300A, 300B may obtain user activity information (such as from the user electronic devices) from a group of subjects to generate menu data indicative of a sharing menu (such as a victual menu) for a group of subjects.

In one or more example electronic devices, the menu data is based on the victual tracking parameter. In other words, the electronic devices disclosed herein (such as electronic devices 300A, 300B) may be configured to generate the menu data based on the victual tracking parameter. In other words, the electronic device 300A, 300B may be configured, based on the detection data (such as based on one or more vision sensors), as the one or more subjects at a victual consumption place are eating, to keep track of a consumption of victual items and/or products by the one or more subjects. A victual tracking parameter may be seen as a parameter associated with a consumption of a victual item and/or object, such as a detected consumption of a victual item and/or object (such as detected by the optical device). A victual tracking parameter may be seen as comprising information indicative of one or more of: consumption of a victual item, quantity of the victual item, portion of the victual item, a state of consumption, and a state (such as solid, liquid, hot and/or cold) of the victual item. In one or more example electronic devices, the optical device may dynamically monitor the consumption of a victual item by one or more subjects. The generation of the menu data may be based on a number of subjects that are tracked, such as a group of subjects that is tracked. For example, when the tracking parameter is based on a tracking of only one or two subjects eating, the electronic device 300A, 300B may be configured to wait for a longer period of time before recommending menu data (such as recommending re-ordering and/or ordering more victual items) than when the tracking parameter is based on a tracking of ten subjects. In one or more example electronic devices, the electronic device 300A, 300B may obtain the detection data dynamically to generate a victual menu. In one or more example electronic devices, the electronic device 300A, 300B may be configured to update the menu data dynamically based on the consumption of the one or more victual items. In one or more example electronic devices, the electronic device 300A, 300B may be configured to dynamically suggest (such as by using the victual ordering system, such as by dispatching and/or displaying the menu data, such as updated menu data) to one or more subjects, a victual item (such as a food item) for consumption. In one or more example electronic devices, the electronic device 300A, 300B may be configured to dynamically suggest (such as by using the victual ordering system, such as by dispatching and/or displaying the menu data, such as updated menu data) a victual item (such as a food item) to one or more subjects, based on the victual tracking parameter, for consumption. For example, staple dishes such as rice, bread, and/or sauce may be timely re-ordered as soon as they are empty. The re-ordering of staple dishes may for example be based on the number subjects that are monitored. For example, when the tracking parameter is based on a tracking of ten subjects, the time period for timely re-reordering may be longer than when the tracking parameter is based on a tracking of two subjects. Optionally, users may need to confirm re-ordering to prevent unnecessary ordering. An advantage of this, may be that it could enable a new type of pricing, for example apportion a cost to uneaten food to show food waste. For example, by having menu data based on the victual tracking parameter, a victual item such as a main dish, a side dish, and/or a dessert may be recommended based on a consumption of previous victual items, such as dishes. This may provide a victual menu comprising a balanced mix and/or a “taste journey” appreciated by the guests (such as subjects).

In one or more example electronic devices, the electronic device is configured to obtain (such as using the processor circuitry 302A, 302B and/or via the interface circuitry 303A, 303B) a first user input. Obtaining the first user input may comprise obtaining user input via the victual ordering system, such as via the victual ordering device 306, such as via the user electronic device. In one or more example electronic devices, the interface circuitry 303A, 303B comprises display circuitry configured to display a user interface and to receive user input. In one or more example electronic devices, the electronic device 300A (such as the victual ordering device 306) is configured to receive a first input from a user via the user interface.

The display circuitry of the electronic device 300A (such as the victual ordering device 306) may be configured to detect the first input (such as a touch input from the user, for example when the display circuitry comprises a touch-sensitive display), the first input may comprise a contact on the touch sensitive display. A touch-sensitive display may provide the user interface (such as an input interface) and an output interface between the electronic device 300A (such as the victual ordering device 306) and the user. The processor circuitry 302A of the electronic device 300A may be configured to receive and/or send electrical signals from/to a touch-sensitive display. A touch-sensitive display may be configured to display visual output to the user. The visual output optionally includes graphics, text, icons, video, and any combination thereof (collectively termed “graphics”). For example, some, most, or all of the visual output may be seen as corresponding to victual items.

The processor circuitry 302A of the electronic device 300A (such as the victual ordering device 306) may be configured to display, on the display circuitry, one or more user interfaces, such as user interface screens, including a first user interface and/or a second user interface. A user interface may comprise one or more, such as a plurality of user interface objects representative of the menu data, such as representative of the victual menu. For example, the first user interface may comprise a first primary user interface object and/or a first secondary user interface object. A second user interface may comprise a second primary user interface object and/or a second secondary user interface object. A user interface object, such as the first primary user interface object and/or the second primary user interface object, may represent a victual item.

The electronic device 300A and/or the victual ordering device 306 may comprise the display circuitry configured to display the user interface for receiving the first input. A user interface may comprise one or more user interface objects. A user interface may be referred to as a user interface screen.

A user interface object refers herein to a graphical representation of an object (such as an object associated with a victual item) that is displayed on the display circuitry of the victual ordering device 306 (such as the user electronic device). The user interface object may be user-interactive (such as a user interactive victual menu), or selectable by the first input (such as a user input). For example, an image (e.g., icon), a button, and text (e.g., hyperlink) each optionally constitute a user interface object. The user interface object may form part of a widget. A widget may be seen as a mini-application that may be used by the user, and created by the user. A user interface object may comprise a prompt, application launch icon, and/or an action menu. An input, such as first input and/or second input, may comprise a touch (e.g., a tap, a force touch, a long press), and/or movement of contact (e.g. a swipe gesture, e.g., for toggling). The movement on contact may be detected by a touch sensitive surface, e.g., on the display circuitry of the electronic device 300A and/or the victual ordering device 306. Thus, the display circuitry may be a touch sensitive display. The first input (such as first user input), such as first input and/or second input, may comprise a lift off. A user input, such as first input and/or second input, may comprise a touch and a movement followed by a lift off. In one or more example electronic devices, the electronic device 300A, 300B may be configured to communicate to a device, such as the victual ordering device 306, the menu data. In other words, the electronic device 300A, 300B may be configured to cause the victual ordering device 306 to display a user interface object representative of the menu data.

In one or more example electronic devices, the interface circuitry 303A, 303B may comprise a user interface, such as a touch enabled user interface, and/or a tactile button. The subject may provide user input via the user interface of the electronic device (such as electronic device 300A, 300B). In one or more example electronic devices, the subject may provide user input via the victual ordering system (such as victual ordering device 306). In one or more example electronic devices, the subject may provide a user input via the user interface on a user electronic device (such as by using an application on mobile phone, and/or on tablet), such as providing a user input indicative of a selection of an object associated with a victual item. In one or more electronic devices, the electronic device 300A, 300B may be configured to control the victual ordering system based on the first user input.

In one or more example electronic devices, the first user input comprises one or more of: a victual preference parameter, an allergy parameter, a taste parameter, a price parameter, a duration parameter, and an activity parameter.

A victual preference parameter may be seen as comprising information indicative of a preference of a victual item, such as one or more of: total calorific intake, portion size, taste, food, drink. In one or more example electronic devices, the electronic device 300A, 300B may be configured to obtain a user input, such as a first user input (such as via the victual ordering device 306) such as a victual preference parameter indicative of a user choice of a victual item (such a food item to consume). In one or more example electronic devices, the electronic device 300A, 300B may be configured to generate, based on the first user input comprising the victual preference parameter, menu data indicative of a victual menu.

An allergy parameter may be seen as comprising information indicative of food item such as food and drinks that the subject is allergic to. In one or more example electronic devices, the electronic device 300A, 300B may be configured to obtain a user input, such as a first user input (such as via the victual ordering device 306) such as an allergy parameter indicative of a victual item (such a food item to consume) that the user is allergic to. In one or more example electronic devices, the electronic device 300A, 300B may be configured to generate, based on the first user input comprising the allergy parameter, menu data indicative of a victual menu. In other words, the electronic device 300A, 300B may be configured to generate, based on the first user input comprising on the allergy parameter, menu data indicative of a victual menu without comprising (such as omitting) victual items that the subject and/or user or the group of subjects is allergic to.

A taste parameter may be seen as comprising information indicative a taste preference of a subject, such as spicy, mild spicy, salty, sweet, bitter, etc. In one or more example electronic devices, the electronic device 300A, 300B may be configured to obtain a user input, such as a first user input (such as through the victual ordering device 306) such as a taste parameter indicative of taste preference associated with a victual item (such a food item to consume). In one or more example electronic devices, the electronic device 300A, 300B may be configured to generate, based on the first user input comprising the taste parameter, menu data indicative of a victual menu. In other words, the electronic device 300A, 300B may be configured to generate, based on the first user input comprising on the taste parameter, menu data indicative of a victual menu comprising one or more victual items that the user and/or the group of users like to consume.

A price parameter may be seen as comprising information indicative a price such as budget limit, price of a victual menu, and/or price of a victual item. In one or more example electronic devices, the electronic device 300A, 300B may be configured to obtain a user input, such as a first user input (through the victual ordering device 306) such as a price parameter indicative of a price (such as price of a victual item, such a food item to consume). In one or more example electronic devices, the electronic device 300A, 300B may be configured to generate, based on the first user input comprising the price parameter, menu data indicative of a victual menu. In one or more example electronic devices, the electronic device 300A, 300B may be configured to generate, based on the first user input comprising on the price parameter, menu data indicative of a victual menu with a price is below the price set by the user. In one or more example electronic devices, the electronic device 300A, 300B may be configured to generate, based on the first user input comprising on the price parameter, menu data indicative of a victual menu with a price is above the price set by the user. In other words, the electronic device 300A, 300B may be configured to generate, based on the first user input comprising on the price parameter, menu data indicative of a victual menu comprising with a price is equal to the price set by the user.

A duration parameter may be seen as comprising information indicative of time such as time to prepare a victual item, such as a cooking time for a certain victual item. A duration parameter may be seen as comprising information indicative of a time taken from “re-ordering” to “serving”. In other words, a duration parameter may also consider a delivery time of a victual item on top of a preparation time. For example, a duration parameter may comprise a total time and/or duration from an order being placed to the ordered victual item being served at a table.

In one or more example electronic devices, the electronic device 300A, 300B may be configured to obtain a user input, such as a first user input (such as through the victual ordering device 306) such as a duration parameter indicative of a user choice of time to prepare (such as a maximum time period a user is willing to wait and/or a time period that a user wants to spend at the victual consumption place, such as meal duration), and/or consume a victual item (such a food item to consume). In one or more example electronic devices, the electronic device 300A, 300B may be configured to generate, based on the first user input comprising the duration parameter, menu data indicative of a victual menu that can be delivered to the user to consume within a time frame of user choice. In one or more example electronic devices, the electronic device 300A, 300B may be configured to generate, based on the first user input comprising the duration parameter, menu data indicative of a victual menu that can be consumed within a time frame of user choice.

An activity parameter, such as a user activity parameter, may be seen as comprising data indicative user activity. In one or more example electronic devices, the electronic device 300A, 300B may be configured to obtain an activity parameter from a user electronic device such as armbands, wrist bands, smart phones, smart headphones, and glasses, which may provide metabolic capacity information of the user. In one or more example electronic devices, the electronic device 300A, 300B may be configured to obtain a user input, such as a first user input (through the victual ordering device 306) such as an activity parameter indicative of user activity data (such a user's daily routine activities, physical activities such as workouts in a gym). In one or more example electronic devices, the electronic device 300A, 300B may be configured to generate, based on the first user input comprising the activity parameter, menu data indicative of a victual menu.

In one or more example electronic devices, the electronic device may be configured to obtain a user input (such a first user input) prior to the arrival of the user at a place (such a victual consumption place, such as a restaurant, a food truck, a canteen, a food take-away place, a bar, etc.). In one or more example electronic devices, the user input (such as a first user input) may be indicative of number of subjects arriving at a victual consumption place. In one or more example electronic devices, the user input (such as a first user input) may be indicative of number of subjects at a victual consumption place.

In one or more example electronic devices, the menu data is based on the first user input. In other words, the electronic device 300A, 300B may be configured to generate, based on the first user input, menu data indicative of a victual menu. In one or more example electronic devices, the first user input comprises one or more of: a victual preference parameter, an allergy parameter, a taste parameter, a price parameter, a duration parameter, and an activity parameter.

In one or more example electronic devices, the electronic device is configured to output (via the interface circuitry 303A, 303B) the menu data to one or more subjects. In one or more example electronic devices, the electronic device 300A, 300B may be configured to output the menu data to one or more subjects operating a victual ordering device 306. In one or more example electronic devices, the electronic device 300A, 300B may be configured to output the menu data to one or more subjects present at a location (such as at a restaurant, a canteen, a food take-away place, a food truck, etc.). In one or more example electronic devices, the electronic device 300A, 300B may be configured to output the menu data to one or more subjects' user electronic device (such as a tablet, a mobile phone etc.). In one or more example electronic devices, the electronic device 300A, 300B may be configured to communicate to a device, such as the victual ordering device 306, the menu data. In other words, the electronic device 300A, 300B may be configured to cause the victual ordering device 306 to display a user interface object representative of the menu data.

In one or more example electronic devices, at a victual location (such as in a restaurant), the electronic device such as the electronic device 300A may obtain detection data, from the optical device (such as a camera device) indicative of an item such as number of subjects at a table. Further, the electronic device 300A may consider additional information such as user input, such as first user input (such as user preferences) and user activity information (such as user metabolic capacity). The electronic device 300A may control the victual ordering system, based on the detection data, recommendation engine and additional information, to generate a victual menu. Further, the electronic device 300A may output the victual menu to one or more users, such as via the victual ordering device 306.

In one or more example electronic devices, the electronic device is configured to obtain (such as using the processor circuitry 302A, 302B and/or via the interface circuitry 303A, 303B) a second user input indicative of one or more of: an acceptance of the victual menu, a refusal of the victual menu, and a modification of the victual menu (such as an interaction of a user on the victual menu).

In one or more example electronic devices, the electronic device 300A, 300B may be configured to obtain a user input, such as a second user input (such as through the victual ordering device 306) such as an acceptance of the victual menu. An acceptance of the victual menu may indicate that a user (such as subject) accepts a content of the victual menu, such as accepts the one or more victual items comprised in the victual menu. In one or more example electronic devices, the electronic device 300A, 300B may be configured to generate, based on the second user input indicative of user acceptance of the victual menu, the victual menu.

In one or more example electronic devices, the electronic device 300A, 300B may be configured to obtain a user input, such as a second user input (such as through the victual ordering device 306) such as a refusal of the victual menu. In one or more example electronic devices, the electronic device 300A, 300B may be configured to generate, based on the second user input indicative of user refusal of the victual menu, a victual menu (such as an updated victual menu and/or a new victual menu).

In one or more example electronic devices, the electronic device 300A, 300B may be configured to obtain a user input, such as a second user input (such as via the victual ordering device 306) such as a modification of the victual menu. In one or more example electronic devices, the electronic device 300A, 300B may be configured to modify, based on the second user input indicative of user modification of the victual menu, the victual menu.

In one or more example electronic devices, the electronic device is configured to determine (such as using the processor circuitry 302A, 302B) whether the menu data is to be updated and/or modified based on the second user input. In other words, in accordance with the user input being indicative of refusal and/or modification of the victual menu, the electronic device 300A, 300B may be configured to update the menu data. In one or more electronic devices, the updating of menu data may comprise generating updated and/or new menu data based on the user input (such as first user input, second user input, etc.) and/or based on updated detection data. In one or more electronic devices, the modification of menu data may comprise modifying the menu data based on the user input (such as first user input, second user input, etc.).

In one or more example electronic devices, the electronic device is a server device.

In one or more example electronic devices, the electronic device comprises the optical device.

In one or more electronic devices, the electronic device 300A, 300B may be configured to identify (such as by using an optical device) one or more victual items (such as a food item, a drink item etc) unattended by the one or more subjects at a victual place (such as at a restaurant during dinner). In one or more electronic devices, the electronic device 300A, 300B may be configured to identify one or more victual items (such as a food item, a drink item etc) partially consumed by the one or more subjects at a victual place (such as at a restaurant during lunch). In one or more electronic devices, the electronic device 300A, 300B may be configured to measure the quantity and/or value of one or more victual items that are ordered by a user and not consumed (and/or partially consumed). In one or more electronic devices, the electronic device 300A, 300B may be configured to determine whether the victual consumption place is complying with institution regulations (such as regulations from the food waste control authority, from a government). In one or more electronic devices, the electronic device 300A, 300B may be configured to store one or more of: a subject and/or group of subjects visit to a victual consumption place, a subject or group of subjects preferences, a subject or group of subjects choice of victual items. In one or more electronic devices, the electronic device 300A, 300B may be configured to store information associated with the menu data (such as labour required to produce one or more victual items associated the with menu data).

In one or more electronic devices, the electronic device 300A, 300B may be configured to determine the labour required to produce one or more victual items based on menu data (such as a victual menu, such a menu of food items to consume). In one or more example, the electronic device 300A, 300B may be configured to generate, using the recommendation engine, menu databased on the user input indicative of user food consumption priorities (such as vegan, vegetarian, and/or non-vegetarian).

The electronic device 300A, 300B optionally configured to perform (such as using Processor circuitry 302A, 302B) any of the operations disclosed in FIG. 2 (such as any one or more of S104, S106, S108, S109, S110A, S110B, S112). The operations of the electronic device 300A, 300B may be embodied in the form of executable logic routines (for example, lines of code, software programs, etc.) that are stored on a non-transitory computer readable medium (for example, memory circuitry 301A, 301B) and are executed by processor circuitry 302A, 302B).

Furthermore, the operations of the electronic device 300A, 300B may be considered a method that the electronic device 300A, 300B is configured to carry out. Also, while the described functions and operations may be implemented in software, such functionality may also be carried out via dedicated hardware or firmware, or some combination of hardware, firmware and/or software.

Memory circuitry 301A, 301B may be one or more of a buffer, a flash memory, a hard drive, a removable media, a volatile memory, a non-volatile memory, a random access memory (RAM), or other suitable device. In a typical arrangement, Memory circuitry 301A, 301B may include a non-volatile memory for long term data storage and a volatile memory that functions as system memory for processor circuitry 302A, 302B. Memory circuitry 301A, 301B may exchange data with processor circuitry 302A, 302B over a data bus. Control lines and an address bus between memory circuitry 301A, 301B and processor circuitry 302A, 302B also may be present (not shown in FIG. 1). Memory circuitry 301A, 301B is considered a non-transitory computer readable medium.

Memory circuitry 301A, 301B may be configured to store detection data, a detection model, a recommendation engine, a first user input, and a second user input in a part of the memory.

FIG. 2 shows a flow diagram of an example method 100, performed by an electronic device according to the disclosure. The method may be performed for recommending a sharing menu. The method 100 may be performed by the electronic device disclosed herein, such as the electronic device 300A, 300B of FIG. 1.

The method 100 comprises obtaining S102, from an optical device, detection data indicative of an item.

In one or more example methods, the obtaining S102 of detection data comprises obtaining first detection data and/or second detection data. In one or more example methods, the obtaining S102 of detection data comprises obtaining detection data from one or more optical devices (such as optical device 304 of FIG. 1) at a location. In one or more example methods, the obtaining S102 of detection data comprises obtaining data indicative of a user activity information from a user electronic device (such as electronic device 300A, 300B, 306 of FIG. 1)

In one or more example methods, the method 100 comprises communicating with the victual communication system. In one or more example methods, the obtaining S102 of detection data comprises obtaining user activity information.

The method 100 comprises controlling S110, based on the detection data, a victual ordering system. In one or more example methods, the controlling S110 of the victual ordering system comprises displaying menu data indicative one or more victual items (such as a food item). In one or more example methods, the controlling the victual ordering system comprises displaying a user interface object representative of the menu data. In one or more example methods, the controlling S110 of the victual ordering system comprises controlling one or more victual orders. In one or more example methods, the controlling S110 of the victual ordering system comprises prioritizing the preparation of a set of victual products and/or items for a group of subjects. In one or more example methods, the controlling S110 of the victual ordering system comprises outputting the menu data.

In one or more example methods, the outputting of the menu data comprises outputting the menu data to an electronic device such as a user electronic device (such as a tablet, a display, and/or a TV). In one or more example methods, the outputting of the menu data comprises outputting the menu data to the victual ordering system.

In one or more example methods, the detection data comprises one or more of: a subject parameter, a group of subjects parameter, an object parameter, a face parameter, a victual parameter, a victual tracking parameter, and a radio sensing parameter.

In one or more example methods, the method 100 comprises detecting one or more items using the optical device.

In one or more example methods, the item comprises one or more of: a victual object, one or more subjects, a pose, and a face.

In one or more example methods, the electronic device comprises a recommendation engine.

In one or more example methods, the method 100 comprises running, executing and/or operating the recommendation engine. In one or more example methods, the method 100 comprises running, executing and/or operating a detection model. In one or more example methods, the method 100 comprises running, executing and/or operating a trained neural network. In one or more example methods, the method 100 comprises obtaining an input from the detection model. In one or more example methods, the recommendation engine and/or the detection model is a trained deep neural network. In one or more example methods, the method 100 comprises modifying, such as by using the recommendation engine, the menu data.

In one or more example methods, the recommendation engine is based on one or more of: collaborative filtering, content-based filtering, session-based recommender, and hybrid systems combining any one or more of the previous

In one or more example methods, the controlling S110 of the victual ordering system comprises generating S110A, based on the detection data and using the recommendation engine, menu data indicative of a victual menu. In one or more example methods, the generation S110A of menu data comprises generating menu data, such as a victual menu indicative of a sharing menu recommendation based on one or more of: collaborative filtering, content-based filtering, session-based recommender, and hybrid systems combining any one or more of the previous.

In one or more example methods, the method 100 comprises controlling S110B the victual ordering system based on the menu data. In one or more example methods, the controlling S110B of the victual ordering system, based on the menu data, may comprise outputting the menu data to an electronic device such as a user electronic device (such as a tablet, a display, and/or a TV). In one or more example methods, controlling the victual ordering system, based on the menu data, may comprise outputting the menu data to a victual ordering device. In one or more example methods, the controlling S110B of the victual ordering system, based on the menu data, may comprise when a user accepts the victual menu, such as accepts the menu data indicative of a victual menu by providing a user input (such as inputting an acceptance of the victual menu), sending and/or dispatching the menu data to an electronic device, such as a user electronic device in a kitchen of a victual consumption place. For example, the method 100 may comprise sending and/or dispatching the menu data to an electronic device configured to display menu data, such as display victual menu. The content of the menu data that has been prepared may then be served when the victual products of the menu data are ready. For example, the method 100 may comprise sending and/or dispatching the menu data to an electronic device, such as a terminal and/or a tablet, in a victual preparation area (such as food preparation area, for example a kitchen in a restaurant).

In one or more example methods, the menu data comprises data indicative of a sharing menu for a group of subjects.

In one or more example methods, the menu data is based on the victual tracking parameter.

In one or more example methods, the method 100 comprises obtaining S104 a first user input. In one or more example methods, obtaining S104 the first user input may comprise obtaining user input via the victual ordering system, such as via the victual ordering device, such as via the user electronic device. In one or more example methods, the method 100 may comprise displaying a user interface and to receive user input. In one or more example methods, the method 100 may comprise receiving a first input from a user via the user interface. In one or more example methods, the method 100 comprises obtaining one or more first user inputs from a group of users and/or subjects.

In one or more example methods, the first user input comprises one or more of: a victual preference parameter, an allergy parameter, a taste parameter, a price parameter, a duration parameter, and an activity parameter.

In one or more example methods, the menu data is based on the first user input.

In one or more example methods, the method 100 comprises suggesting an item (such as a victual item) to a subject.

In one or more example methods, the method 100 comprises receiving and/or sending electrical signals from/to a touch-sensitive display.

In one or more example methods, the method 100 comprises outputting S112 the menu data to one or more subjects.

In one or more example methods, outputting S112 the menu data to one or more subjects may comprise outputting the menu data to one or more subjects operating a victual ordering device. In one or more example methods, the method 100 may comprise outputting the menu data to one or more subjects present at a location (such as at a restaurant, a canteen, a food take-away place, a food truck, etc.). In one or more example methods, the method 100 may comprise outputting the menu data to one or more subjects' user electronic device(s) (such as a tablet, a mobile phone etc.). In one or more example methods, the method 100 may comprise communicating to a device, such as the victual ordering device, the menu data. In other words, the method 100 may comprise causing the victual ordering device to display a user interface object representative of the menu data.

In one or more example methods, the method 100 comprises obtaining S106 a second user input indicative of one or more of: an acceptance of the victual menu, a refusal of the victual menu, and a modification of the victual menu. In one or more example methods, the method 100 may comprise obtaining a user input, such as a second user input (such as through the victual ordering device) such as an acceptance of the victual menu. An acceptance of the victual menu may indicate that a user (such as subject) accepts a content of the victual menu, such as accepts the one or more victual items comprised in the victual menu. In one or more example methods, the method 100 may comprise generating, based on the second user input indicative of user acceptance of the victual menu, the victual menu. In one or more example methods, the method 100 comprises obtaining the second user input from a group of users.

In one or more example methods, the method 100 comprises determining S108 whether the menu data is to be updated and/or modified based on the second user input.

In one or more example methods, the method 100 comprises, in accordance with the determination that the menu data is to be updated and/or modified, updating and/or modifying, based on the second user input, the menu data (such as the victual menu).

In one or more example methods, the method 100 comprises, in accordance with the determination that the menu data is not to be updated and/or modified, refraining S109 from updating and/or modifying, based on the second user input, the menu data (such as the victual menu). In one or more example methods, the updating of the menu data comprises generating updated and/or new menu data based on the user input (such as second user input).

In one or more example methods, the electronic device is a server device.

In one or more example methods, the electronic device comprises the optical device.

Examples of methods and products (the electronic device) according to the disclosure are set out in the following items:
Item 1. An electronic device (300A, 300B) comprising:
   memory circuitry (301A, 301B);
   processor circuitry (302A, 302B);
   and interface circuitry (303A, 303B);
wherein the electronic device (300A, 300B) is configured to:
   obtain, from an optical device, detection data indicative of an item; and
   control, based on the detection data, a victual ordering system.
Item 2. The electronic device according to item 1, wherein the detection data comprises one or more of: a subject parameter, a group of subjects parameter, an object parameter, a face parameter, a victual parameter, a victual tracking parameter, and a radio sensing parameter.
Item 3. The electronic device according to any of the previous items, wherein the item comprises one or more of: a victual object, one or more subjects, a pose, and a face.
Item 4. The electronic device according to any of the previous items, wherein the electronic device comprises a recommendation engine.
Item 5. The electronic device according to item 4, wherein the recommendation engine is based on one or more of: collaborative filtering, content-based filtering, session-based recommender, and hybrid systems combining any one or more of the previous.
Item 6. The electronic device according to any of items 4-5, wherein the controlling of the victual ordering system comprises to generate, based on the detection data and using the recommendation engine, menu data indicative of a victual menu.
Item 7. The electronic device according to item 6, wherein the electronic device is configured to control the victual ordering system based on the menu data.
Item 8. The electronic device according to any of items 6-7, wherein the menu data comprises data indicative of a sharing menu for a group of subjects.
Item 9. The electronic device according to any of items 6-8, wherein the menu data is based on the victual tracking parameter.
Item 10. The electronic device according to any of the previous items, wherein the electronic device is configured to obtain a first user input, wherein the first user input comprises one or more of: a victual preference parameter, an allergy parameter, a taste parameter, a price parameter, a duration parameter, and an activity parameter.
Item 11. The electronic device according to item 10, wherein the menu data is based on the first user input.
Item 12. The electronic device according to any of the items 6-11, wherein the electronic device is configured to output the menu data to one or more subjects.
Item 13. The electronic device according to item 12, wherein the electronic device is configured to obtain a second user input indicative of one or more of: an acceptance of the victual menu, a refusal of the victual menu, and a modification of the victual menu.
Item 14. The electronic device according to item 13, wherein the electronic device is configured to determine whether the menu data is to be updated and/or modified based on the second user input.
Item 15. The electronic device according to any of the previous items, wherein the electronic device is a server device.
Item 16. The electronic device according to any of the previous items, wherein the electronic device comprises the optical device.
Item 17. A method, performed by an electronic device, the method comprising:
   obtaining (S102), from an optical device, detection data indicative of an item; and
   controlling (S110), based on the detection data, a victual ordering system.
Item 18. The method according to item 17, wherein the detection data comprises one or more of: a subject parameter, a group of subjects parameter, an object parameter, a face parameter, a victual parameter, a victual tracking parameter, and a radio sensing parameter.
Item 19. The method according to items 17-18, wherein the item comprises one or more of: a victual object, one or more subjects, a pose, and a face.
Item 20. The method according to items 17-19, wherein the electronic device comprises a recommendation engine.
Item 21. The method according to item 20, wherein the recommendation engine is based on one or more of: collaborative filtering, content-based filtering, session-based recommender, and hybrid systems combining any one or more of the previous.
Item 22. The method according to item 21, wherein the controlling (S110) of the victual ordering system comprises generating (S110A), based on the detection data and using the recommendation engine, menu data indicative of a victual menu.
Item 23. The method according to item 22, wherein the method comprises controlling (S110B) the victual ordering system based on the menu data.
Item 24. The method according to items 22-23, wherein the menu data comprises data indicative of a sharing menu for a group of subjects.
Item 25. The method according to items 19-24, wherein the menu data is based on the victual tracking parameter.
Item 26. The method according to items 17-25, wherein the method comprises obtaining (S104) a first user input, wherein the first user input comprises one or more of: a victual preference parameter, an allergy parameter, a taste parameter, a price parameter, a duration parameter, and an activity parameter.
Item 27. The method according to item 26, wherein the menu data is based on the first user input.
Item 28. The method according to items 22-27, wherein the method comprises outputting (S112) the menu data to one or more subjects.
Item 29. The method according to item 28, wherein the method comprises obtaining (S106) a second user input indicative of one or more of: an acceptance of the victual menu, a refusal of the victual menu, and a modification of the victual menu.
Item 30. The method according to item 29, wherein the method comprises determining (S108) whether the menu data is to be updated and/or modified based on the second user input.
Item 31. The method according to items 17-30, wherein the electronic device is a server device.
Item 32. The method according to items 17-31, wherein the electronic device comprises the optical device.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that the Figures comprise some circuitries or operations which are illustrated with a solid line and some circuitries, components, features, or operations which are illustrated with a dashed line. Circuitries or operations which are comprised in a solid line are circuitries, components, features or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented.

Furthermore, it should be appreciated that not all of the operations need to be performed. The example operations may be performed in any order and in any combination. It should be appreciated that these operations need not be performed in order presented. Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount. If the stated amount is 0 (e.g., none, having no), the above recited ranges can be specific ranges, and not within a particular % of the value. For example, within less than or equal to 10 wt./vol. % of, within less than or equal to 5 wt./vol. % of, within less than or equal to 1 wt./vol. % of, within less than or equal to 0.1 wt./vol. % of, and within less than or equal to 0.01 wt./vol. % of the stated amount.

The various example methods, devices, nodes, and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. An electronic device comprising:
memory circuitry;
processor circuitry; and
interface circuitry;
wherein the electronic device is configured to:
obtain, from an optical device, detection data indicative of an item; and
control, based on the detection data, a victual ordering system;
wherein the electronic device comprises a recommendation engine, and wherein the controlling of the victual ordering system comprises to generate, based on the detection data and using the recommendation engine, menu data indicative of a victual menu.

2. The electronic device according to claim 1, wherein the detection data comprises one or more of: a subject parameter, a group of subjects parameter, an object parameter, a face parameter, a victual parameter, a victual tracking parameter, and a radio sensing parameter.

3. The electronic device according to claim 1, wherein the item comprises one or more of: a victual object, one or more subjects, a pose, and a face.

4. The electronic device according to claim 1, wherein the recommendation engine is based on one or more of: collaborative filtering, content based filtering, session-based recommender, and hybrid systems combining any one or more of the previous.

5. The electronic device according to claim 1, wherein the electronic device is configured to control the victual ordering system based on the menu data.

6. The electronic device according to claim 1, wherein the menu data comprises data indicative of a sharing menu for a group of subjects.

7. The electronic device according to claim 2, wherein the menu data is based on the victual tracking parameter.

8. The electronic device according to claim 1, wherein the electronic device is configured to obtain a first user input, wherein the first user input comprises one or more of: a victual preference parameter, an allergy parameter, a taste parameter, a price parameter, a duration parameter, and an activity parameter.

9. The electronic device according to claim 8, wherein the menu data is based on the first user input.

10. The electronic device according to claim 1, wherein the electronic device is configured to output the menu data to one or more subjects.

11. The electronic device according to claim 10, wherein the electronic device is configured to obtain a second user input indicative of one or more of: an acceptance of the victual menu, a refusal of the victual menu, and a modification of the victual menu.

12. The electronic device according to claim 11, wherein the electronic device is configured to determine whether the menu data is to be updated and/or modified based on the second user input.

13. The electronic device according to claim 1, wherein the electronic device is a server device.

14. The electronic device according to claim 1, wherein the electronic device comprises the optical device.

15. A method, performed by an electronic device, the method comprising:
obtaining, from an optical device, detection data indicative of an item; and
controlling, based on the detection data, a victual ordering system
wherein the electronic device comprises a recommendation engine and wherein the controlling of the victual ordering system comprises generating, based on the detection data and using the recommendation engine, menu data indicative of a victual menu.

16. The method according to claim 15, wherein the detection data comprises one or more of: a subject parameter, a group of subjects parameter, an object parameter, a face parameter, a victual parameter, a victual tracking parameter, and a radio sensing parameter.

17. The method according to claim 15, wherein the item comprises one or more of: a victual object, one or more subjects, a pose, and a face.

18. The method according to claim 15, wherein the recommendation engine is based on one or more of: collaborative filtering, content-based filtering, session based recommender, and hybrid systems combining any one or more of the previous.

19. The method according to claim 15, wherein the method comprises controlling the victual ordering system based on the menu data.

20. The method according to claim 15, wherein the menu data comprises data indicative of a sharing menu for a group of subjects.
